(19) United States
(12) Patent Application Publication
(10) Pub. No.: US 2026/0236638 A1
(43) Pub. Date: Aug. 13, 2026

(54) DATA DRIVEN AGENT-BASED SIMULATION SYSTEM

(71) Applicant: The United States of America, as represented by the Secretary of the Navy, Arlington, VA (US)

(72) Inventor: Glenn-Iain Gregory Steinback, San Diego, CA (US)

(21) Appl. No.: 19/272,069

(22) Filed: Jul. 17, 2025

Related U.S. Application Data
(60) Provisional application No. 63/755,635, filed on Feb. 7, 2025.

(51) Int. Cl. G06F 30/20; G06F 111/02

(52) U.S. Cl. CPC G06F 30/20; G06F 2111/02

(57) ABSTRACT

A computer-implemented method, performed by a data interface module of an agent-based simulation platform, includes receiving a vehicle tracking dataset that is based on recorded movements of multiple vehicles. The dataset includes a first indication of a type, name or unique identifier of each respective vehicle, and a second indication of an initial location, course, and speed of the vehicle. Each entry in the dataset further includes one or more vectors of subsequent locations and speeds of the vehicles. The method further includes converting the entries included in the dataset into corresponding agents that are to be simulated by the simulation platform. The data interface module then instantiates the agents and updates one or more navigation actions of the agents based on vectors included in the dataset.

### REFERENCE TO RELATED APPLICATIONS

This application claims priority to U.S. Provisional Application No. 63/755,635 filed February 07, 2025, which is hereby incorporated by reference.

### FEDERALLY-SPONSORED RESEARCH AND DEVELOPMENT

The United States Government has ownership rights in one or more inventions provided in this disclosure. Licensing inquiries may be directed to Office of Research and Technical Applications, Naval Information Warfare Center Pacific, Code 72110, San Diego, CA, 92152; (619) 553-5118; NIWC_Pacific_T2@us.navy.mil. Reference Navy Case No. 212118.

### TECHNICAL FIELD

Aspects of the present disclosure relate generally to agent-based simulation systems, and in particular but not exclusively, relate to agent-based simulation systems with agents that are generated from real-world data, measurements, or observations of vehicle movements.

### BACKGROUND OF THE INVENTION

Agent-based simulation (ABS), also referred to as agent-based modeling (ABM), is a computational modeling approach where a system is simulated as a collection of autonomous "agents." These agents interact with each other and their environment according to a set of rules. The simulation tracks these interactions and an emergent behavior of the system arises from the collective actions of the agents. Each agent of an ABS system may have its own diverse attributes, behaviors, and decision-making rules. In addition, the agents may interact with one another and the environment, where complex system level behaviors may then emerge.

ABS may be used to model a wide range of phenomena, including social systems, ecological systems, and economic systems. It's particularly useful for understanding how individual decisions and interactions can lead to large-scale patterns. Recently, ABS has been utilized for modeling maritime and/or air traffic. Such simulations may be used for analyzing traffic patterns, for developing traffic flow optimizations, for risk assessment in particular areas and/or situations, for port planning and design, for emergency response planning, and/or for generating training scenarios for maritime and/or air traffic professionals, such as pilots, captains, port operators, and controllers.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates an agent-based simulation system, in accordance with aspects of the disclosure.

FIG. 2 illustrates several real-world vehicles, vehicle tracking data sources, and a data setup platform, in accordance with aspects of the disclosure.

FIG. 3A illustrates an example raw data that include recorded movements of several vehicles, in accordance with aspects of the disclosure.

FIG. 3B illustrates an example vehicle tracking dataset, in accordance with aspects of the disclosure.

FIG. 3C illustrates the example raw data of FIG. 3A formatted into a vehicle tracking dataset, in accordance with aspects of the disclosure.

FIG. 4 illustrates an agent-based simulation platform, in accordance with aspects of the disclosure.

FIG. 5 illustrates an example graphical user interface of an agent-based simulation platform, in accordance with aspects of the disclosure.

FIG. 6 is a flow diagram of an example process performed by an agent-based simulation platform, in accordance with aspects of the disclosure.

FIG. 7 is a visualization of a lookup table for mapping entries to agent types, in accordance with aspects of the disclosure.

FIG. 8 is a flow diagram of an example process of mapping entries to agent types, in accordance with aspects of the disclosure.

FIG. 9 is a flow diagram of an example process of determining an aerial vehicle status, in accordance with aspects of the disclosure.

### DETAILED DESCRIPTION

Embodiments of a device, method, and computer-readable media for a data driven agent-based simulation system are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As mentioned above, agent-based simulation (ABS) may be utilized for modeling maritime traffic and/or air traffic, where each vehicle (e.g., aircraft, watercraft, etc.) included in the simulation is an individual agent. However, building simulation scenarios that accurately reproduce the behaviors, circumstances, and situations of real-world events is time consuming. Identifying the specific types of vehicles involved, their descriptive characteristics, initial locations, and actions over time requires a substantial modeling time investment. Furthermore, once identified, programming these entities in a simulation environment requires additional commitment by the modeler for each simulation environment or tool in which they wish to reproduce the scenario. Additionally, the time required increases with the length of the real-world event to simulate, the number of objects being simulated, and the complexity of their observed actions.

Accordingly, aspects of the present disclosure provide a data driven agent-based simulation system that produces agents for a simulation based on an automated processing of recorded data and/or observations of actual movements of real-world vehicles. This recorded data may be collected from a variety of vehicle tracking data sources, such as antenna stations, radar stations, other intelligence, surveillance, and reconnaissance (ISR) data feeds, and/or commercial sources that provide descriptive information regarding the movements of vehicles over time and through a geographic region.

As will be described in more detail below, aspects of the present disclosure may expedite the simulation process by allowing for the quick and automated ingestion of recorded vehicle tracking data of a real-world event, geographic region, and/or time period. In addition to reducing the time and effort to generate the simulation, aspects of the present disclosure further increase simulation realism such that the resultant agents mirror the descriptive attributes, locations, speed, appearance, and behavior over time of actual vehicles that are described in the recorded vehicle tracking data.

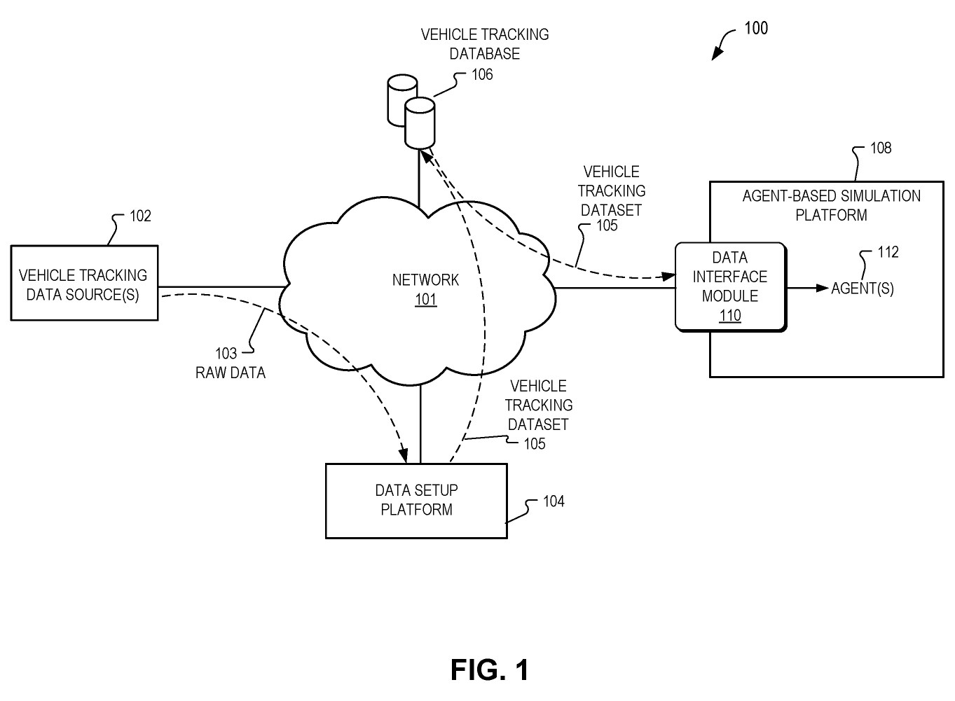

By way of example, FIG. 1 illustrates an agent-based simulation system 100, in accordance with aspects of the disclosure. Agent-based simulation system 100 is shown as including a data setup platform 104, a vehicle tracking database 106, and an agent-based simulation platform 108. Agent-based simulation platform 108 is shown as including a data interface module 110 and one or more agents 112. Also shown in FIG. 1 is a network 101, vehicle tracking sources 102, raw data 103, and a vehicle tracking dataset 105.

In some aspects, network 101 includes a number of routing agents and processing agents. The network 101 may be a local or global system of interconnected computers and computer networks that use a common communication protocol over digital interconnections. For example, network 101 may utilize an Internet protocol suite (e.g., the Transmission Control Protocol (TCP) and IP) for communication among disparate devices and networks.

In FIG. 1, the vehicle tracking data sources 102, the data setup platform 104, the vehicle tracking database 106, and the agent-based simulation platform 108 are connected to the network 101 directly (e.g., over an Ethernet connection or Wi-Fi or 802.11-based network) or indirectly via another intermediate network (e.g., the Internet). In some examples, vehicle tracking data sources 102, the data setup platform 104, the vehicle tracking database 106, and the agent-based simulation platform 108 each include a desktop computer, a network storage device, a laptop computer, a tablet computer, a PDA, a smart phone, or the like. In other examples, vehicle tracking data sources 102, the data setup platform 104, the vehicle tracking database 106, and the agent-based simulation platform 108 may be connected to network 101 via an optical communication system, a cable modem, a digital subscriber line (DSL) modem, or the like.

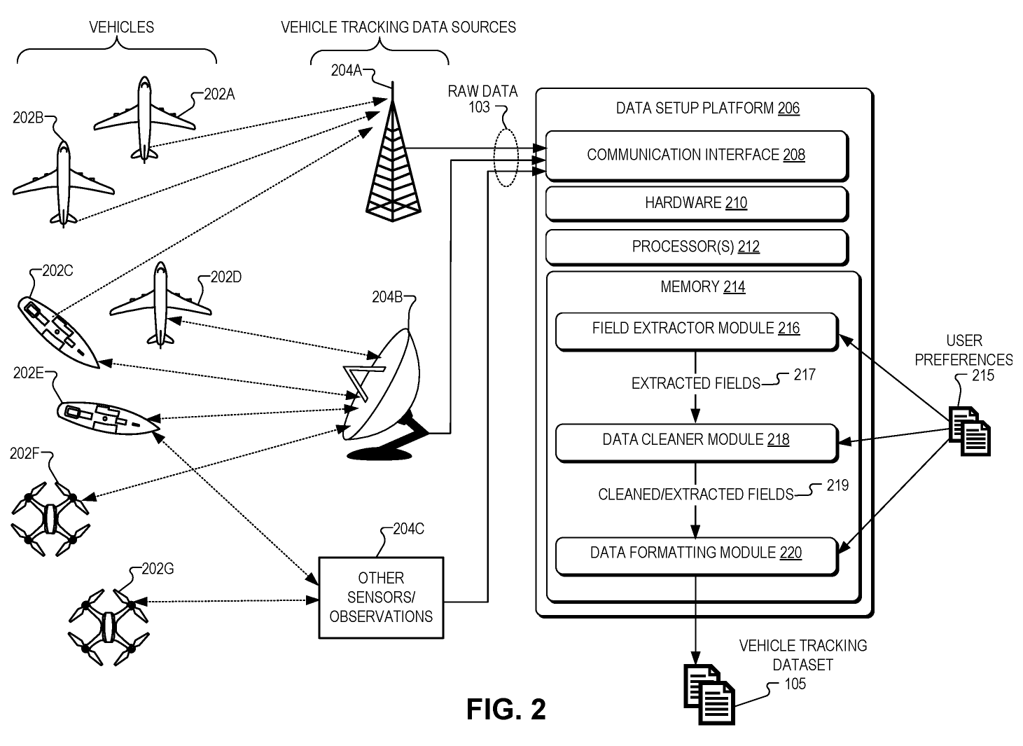

In the illustrated example, data setup platform 104 is a computing device that includes one or more modules for ingesting raw data 103 received from one or more vehicle tracking data sources 102. The data setup platform 104 may then clean and format the raw data 103 to generate a vehicle tracking dataset 105 that is based on a plurality of instances of recorded movements of real-world vehicles. For instance, FIG. 2 illustrates several real-world vehicles 202A-202G, vehicle tracking data sources 204A-204C, and a data setup platform 206, in accordance with aspects of the disclosure. Vehicle tracking data sources 204A-204C are possible implementations of vehicle tracking data sources 102 and data setup platform 206 is one possible implementation of data setup platform 104 of FIG. 1.

As shown in FIG. 2, the vehicle tracking data sources 204A-204C are configured to collect, generate, and provide raw data 103 to the data setup platform 206. In some aspects, the raw data 103 includes recorded movements of vehicles 202A-202G over time within a geographic area and may be in a human-readable format, such as one or more text-based entries that each represent a vehicle’s position at a particular observed time. For example, the raw data 103 may be one or more comma separated value (CSV) files that include plain text. In some aspects, vehicle tracking data source 204A may be a radio station or antenna that receives, records, and relays position information that is actively transmitted by vehicles 202A-202C. In this example, vehicle tracking data source 204A may be an Automatic Identification System (AIS) receiver or base station that receives AIS data broadcast by one or more watercraft vehicles, such as vehicle 202C. In another example, the vehicle tracking data source 204A may be an Automatic Dependent Surveillance-Broadcast (ADS-B) receiver or base station that receives ADS-B data broadcast by one or more aircraft vehicles, such as vehicles 202A and 202B.

FIG. 2 further illustrates a vehicle tracking data source 204B which is also configured to collect, generate, and provide raw data 103. In some examples, vehicle tracking data source 204B is a radar system or installation that is configured to generate the raw data 103. Such radar systems include a primary radar system that generates raw data 103 by reflecting signals off one or more vehicles 202D-202F, or may also includes a secondary radar system that generates an interrogation signal to trigger one or more of the vehicles 202D-202F to transmit vehicle tracking information in response thereto.

In yet another example, raw data 103 may be generated by one or more other sensors/observations 204C. Other sensors included in 204C may include optical sensors (e.g., satellite imagery, LIDAR, etc.), acoustic sensors (e.g., hydrophones), radio frequency (RF) emission detectors, and commercially-available vehicle traffic data (e.g., AIS data providers, flight trackers, port authorities, etc.).

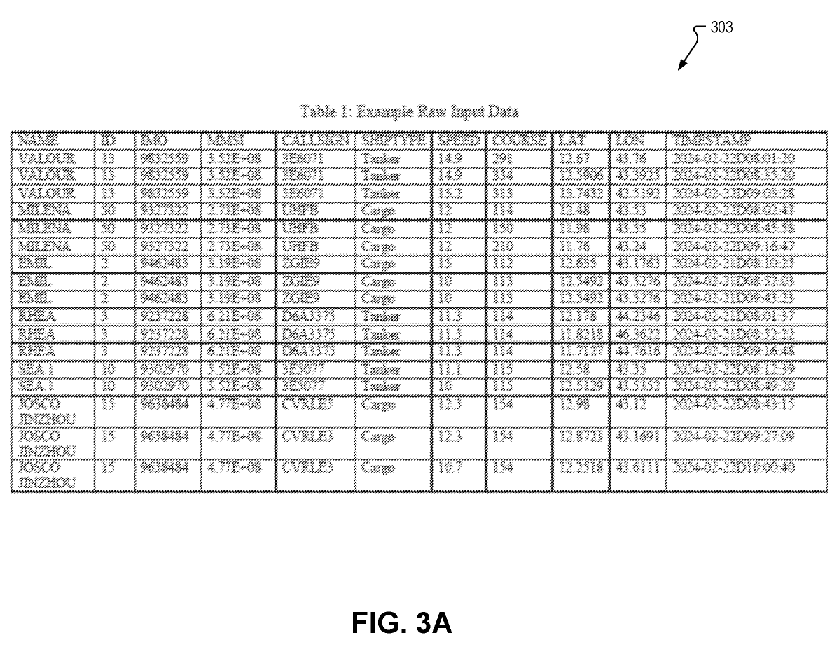

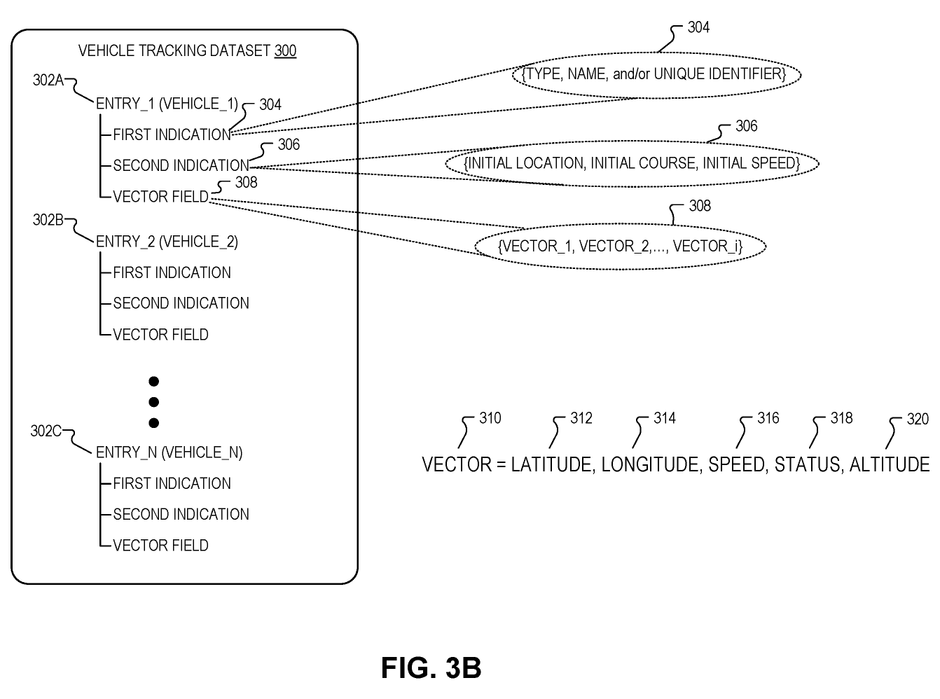

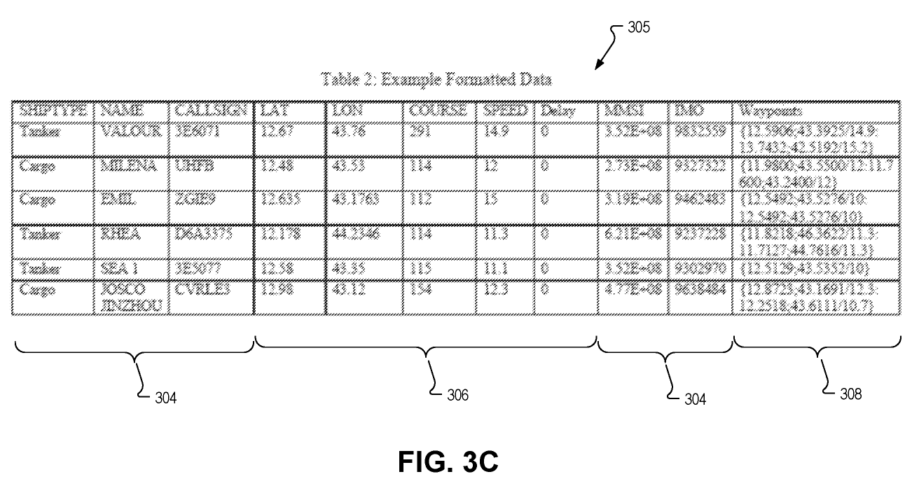

Thus, raw data 103 of recorded vehicle movements may be generated by a variety of vehicle tracking data sources 204A-204C and may be in a variety of formats (e.g., AIS, ADS-B, RADAR, etc.). In some embodiments, the raw data 103 may come from any vehicle tracking data source provided that the raw data 103 contains a minimum amount of information such as: a unique vehicle identifier, a geographic position, a heading, a speed, and an observation timestamp. FIG. 3A illustrates an example raw data 303 that includes recorded movements of several vehicles, in accordance with aspects of the disclosure. Raw data 303 is one possible implementation of raw data 103 of FIGS. 1 and 2. In the example of FIG. 3A, each entry (row) of raw data 303 includes a position, speed, and course of a particular vehicle at a specific time. Thus, as shown in FIG. 3A, each vehicle may include multiple entries within raw data 303 corresponding to multiple different observations of the vehicle at different times. In fact, although FIG. 3A illustrates only 2 or 3 entries per vehicle, in practice, raw data 303 may often include many more entries per vehicle, such as dozens or hundreds of entries. Furthermore, although FIG. 3A only illustrates raw data 303 as including eleven (11) fields (i.e., NAME, ID, IMO, MMSI, CALLSIGN, SHIPTYPE, SPEED, COURSE, LAT, LON, and TIMESTAMP), in practice raw data 303 may include many more data fields. These additional fields have been omitted from illustration of the raw data 303 in FIG. 3A for ease of explanation. As will be described below, the data setup platform 206 is configured to clean, consolidate, and format the raw data 303 into a consistent form for the downstream ingestion by one or more agent-based simulation platforms.

For example, referring back to FIG. 2, data setup platform 206 is shown as including a communication interface 208, hardware 210, one or more processors 212, and a memory 214. Also shown in FIG. 2 is a user preferences file 215.

The communication interface 208 may include wireless and/or wired communication components that enable the data setup platform 206 to transmit data to and receive data from other networked devices. This communication may involve, for example, sending and receiving messages, parameters, or other types of information on network 101 of FIG. 1. The hardware 210 may include additional hardware interfaces, data communication, or data storage hardware. For example, the hardware interfaces may include a data output device (e.g., electronic display, audio speakers), and one or more data input devices (e.g., keypads, keyboards, mouse devices, touch screens, microphones, etc.).

The processor 212 of data setup platform 206 may execute instructions and perform tasks under the direction of software components that are stored in memory 214. For example, the memory 214 may store various software components that are executable or accessible by the one or more processors 212 of the data setup platform 206. The various components may include a field extractor module 216, a data cleaner module 218, and a data formatting module 220.

The field extractor module 216, the data cleaner module 218, and the data formatting module 220 may each include routines, program instructions, objects, and/or data structures that perform particular tasks or implement particular abstract data types. For example, the field extractor module 216 may receive the raw data 103 and extract one or more fields (i.e., extracted fields 217) from the raw data 103 according to a user preferences file 215. That is, in some implementations, the user preferences file 215 is provided that instructs the field extractor module 216 which fields within the raw data 103 that are to be extracted. For example, AIS data may include some fields that need not be extracted and/or are not necessary for inclusion in the vehicle tracking dataset. For instance, AIS data fields such as “ETA, DESTINATION, TYPE OF POSITIONING SYSTEM, RATE OF TURN, etc.,” may be excluded and thus, not extracted by field extractor module 216. Thus, the user preferences file 215 may instruct the field extractor module 216 to omit these specific fields from the extracted fields 217. In addition, the user preferences file 215 may also instruct the field extractor module 216 as to which fields within the raw data 103 are expected to contain specific data. Thus, user preferences file 215 may include configuration information for each type of raw data 103 that is to be received by the data setup platform 206 (e.g., AIS data configuration, ADS-B data configuration, radar data configuration, etc.). Having a user preferences file 215 that provides configuration information allows utilization of numerous different types of vehicle tracking data sources and also allows integration with future vehicle tracking data sources with minimal modifications needed.

The data cleaner module 218 receives and analyzes the extracted fields 217 to discard entries that have missing, incomplete, or malformed data. For example, the data cleaner module 218 may delete an entire entry if the data included in one or more fields of that entry are blank or incomplete. In some examples, the user preferences file 215 may specify which fields are required to contain complete data as opposed to other fields which may be optional. By way of particular example, a vehicle name may be optional, whereas the position information may be mandatory.

In some instances, the frequency or rate at which observations are recorded in the raw data 103 exceeds the frequency or rate at which are needed for effective simulation of an agent. Accordingly, in some examples, the user preferences file 215 may specify a sampling interval. In some aspects, the data cleaner module 218 iterates over the extracted fields 217, applying the sampling interval in order to discard entries that occur more often than the sampling interval. For example, the data cleaner module 218 may look at all entries corresponding to a particular vehicle and place them in chronological order (e.g., by observation timestamp). If the time between sequential entries is less than the specified sampling interval, then one or more of those entries may be deleted. The data cleaner module 218 then outputs the cleaned/extracted fields 219 to the data formatting module 220.

The data formatting module 220 is configured to iterate through the cleaned/extracted fields 219 to find all observations associated with a vehicle and consolidates those entries from a long data form (i.e., one entry per observation of a vehicle) to a wide format (i.e., one entry per vehicle). In particular, the data formatting module 220 is configured to generate the vehicle tracking dataset 105 based on the plurality of recorded movements included in the cleaned/extracted fields 219. In some aspects, the generated vehicle tracking dataset 105 includes no more than one entry for each vehicle observed in the raw data 103. Furthermore, a single respective entry included in the vehicle tracking dataset 105 may be based on a plurality of instances of recorded movements for a respective vehicle observed in the raw data 103.

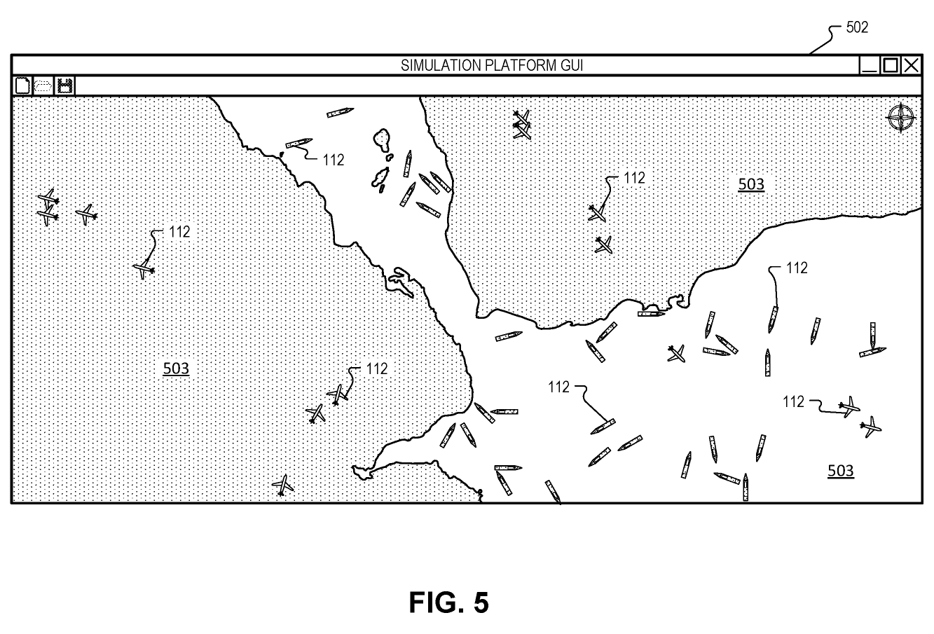

By way of example, FIG. 3B illustrates an example vehicle tracking dataset 300, in accordance with aspects of the disclosure. The illustrated vehicle tracking dataset 300 is one possible data structure for the implementation of vehicle tracking dataset 105 of FIGS. 1 and 5. Vehicle tracking dataset 300 is shown as including multiple entries 302A-302C. As mentioned above, in some aspects, each entry included in the vehicle tracking dataset 300 corresponds to one or more recorded movements of a real-life vehicle and the vehicle tracking dataset 300 includes no more than one entry per vehicle.

FIG. 3B further illustrates each entry as including a first indication 304, a second indication 306, and a vector field 308. In some aspects, the first indication 304 is of a type, a name, or a unique identifier of the corresponding vehicle. In some implementations, the first indication 304 may include one or more of the type, name, or unique identifier fields. In some aspects, the TYPE field included in the first indication 304 may be the SHIPTYPE field extracted from AIS raw data. In another example, the TYPE field may be the aircraft category or emitter category field extracted from ADS-B raw data. The UNIQUE IDENTIFIER included in the first indication 304 may include a callsign, IMO, MMSI, and/or transponder code of the vehicle.

As shown in FIG. 3B, the second indication 306 may contain information regarding an initial location, an initial course, and an initial speed of the vehicle. As discussed above, the data setup platform 206 may iterate through the raw data 103 to look at all entries corresponding to a particular vehicle and then sort them in chronological order (e.g., by observation timestamp). The initial location (i.e., LAT/LONG, Altitude, etc.), initial course, and initial speed may be taken from the first chronological entry of the raw data for this vehicle.

Further included in each entry of vehicle tracking dataset 300 is a vector field 308. The vector field 308 may be a text string that includes at least one vector of a second location and a second speed of the vehicle. The second location and second speed are subsequent to its initial location and initial speed of the second indication 306. Vector field 308 may include any number of time-ordered vectors including one or more.

FIG. 3B further illustrates an example vector 310. Vector 310 is one possible implementation of each vector (e.g., VECTOR_1, VECTOR_2,…,VECTOR_i) included in the vector field 308. Vector 310 is shown as including a latitude 310, a longitude 314, and a speed 316. Vector 310 may also include an optional status indicator 318 and an optional altitude 320. In some implementations, vector 310 may include status indicator 318 to indicate a delay status of the vehicle. For instance, a delay may indicate an amount of time that a vehicle is stationary (e.g., a ship at port, an aircraft on a runway, etc.). As will be described in more detail below, in some implementations, the status indicator 318 may be an aerial vehicle status that indicates whether an aircraft vehicle is in an in-flight status, an on-ground status, a landing status, or a take-off status.

FIG. 3C illustrates the example raw data 303 of FIG. 3A formatted into a vehicle tracking dataset 305 according to the data structure provided in FIG. 3B. In particular, vehicle tracking dataset 305 may be formatted in a comma separated value (CSV) file that includes plain text, where the first indication 304 includes SHIPTYPE, NAME, CALLSIGN, MMSI, and IMO fields. The second indication 306 includes the initial LAT, LON, COURSE, SPEED, and a Delay fields, and where the vector fields 308 include multiple time-ordered latitudes, longitudes, and corresponding speeds.

Referring now back to FIG. 1, data setup platform 104 provides the vehicle tracking dataset 105 for storage in the vehicle tracking database 106. In some examples, the vehicle tracking database 106 includes one or more vehicle tracking datasets stored as comma separated value (CSV) files generated by the data setup platform 104. In one aspect, data setup platform 104 generates and stores vehicle tracking datasets to the vehicle tracking database 106 offline and independent of the operation of the agent-based simulation platform 108. In some examples, multiple vehicle tracking datasets 105 are stored in vehicle tracking database 106 indexed by geographic region, timeframe, event type, and/or scenario. Thus, in some implementations a particular vehicle tracking dataset 105 may be retrieved to generate a particular simulation by one or more agent-based simulation platforms. For example, the agent-based simulation platform 108 may retrieve a vehicle tracking dataset 105 specific to a particular geographic region, date, and/or time of day in order to run a specific simulation.

Accordingly, the data setup platform 104 and vehicle tracking database 106 allows a common data output to produce the same or similar simulations for different simulation tools or platforms. Thus, in some examples, each simulation platform that receives a vehicle tracking dataset 105 includes a data interface module for converting the vehicle tracking dataset 105 into agents that are to be simulated by that specific simulation platform. For example, as shown in FIG. 1, agent-based simulation platform 108 includes data interface module 110 that is configured to receive the vehicle tracking dataset 105. The data interface module 110 is further configured to convert at least one entry of the vehicle tracking dataset 105 into a corresponding agent 112 that is to be simulated by the agent-based simulation platform 108.

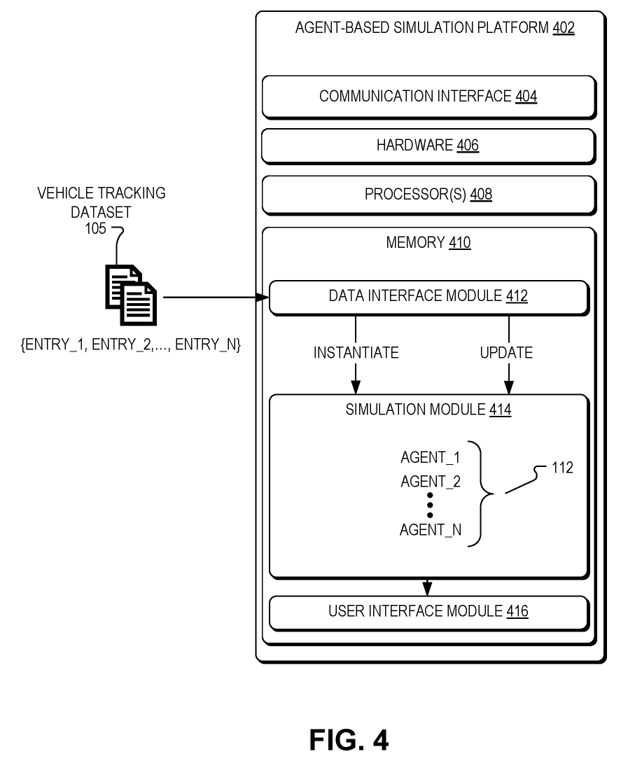

FIG. 4 illustrates an example agent-based simulation platform 402, in accordance with aspects of the disclosure. Agent-based simulation platform 402 is one possible implementation of agent-based simulation platform 108 of FIG. 1. Agent-based simulation platform 402 is shown as including a communication interface 404, hardware 406, one or more processors 408, and a memory 410.

The communication interface 404 may include wireless and/or wired communication components that enable the agent-based simulation platform 402 to transmit data to and receive data from other networked devices. This communication may involve, for example, sending and receiving messages, parameters, or other types of information on network 101 of FIG. 1. The hardware 406 may include additional hardware interfaces, data communication, or data storage hardware. For example, the hardware interfaces may include a data output device (e.g., electronic display, audio speakers), and one or more data input devices (e.g., keypads, keyboards, mouse devices, touch screens, microphones, etc.).

The processor 408 of agent-based simulation platform 402 may execute instructions and perform tasks under the direction of software components that are stored in memory 410. For example, the memory 410 may store various software components that are executable or accessible by the one or more processors 408 of the agent-based simulation platform 402. The various components may include a data interface module 412, a simulation module 414, and a user interface module 416.

The simulation module 414 may include routines, program instructions, objects, and/or data structures that perform particular tasks or implement particular abstract data types that perform particular agent-based simulation tasks, as described herein for modeling the behavior of autonomous agents 112 and their interactions with each other within a maritime and/or air traffic environment. In some aspects, the simulation generated by the simulation module 414 is fed to a user interface module 416 for generating a graphical user interface. For example, FIG. 5 illustrates an example graphical user interface (GUI) 502 generated by the user interface module 416. GUI 502 is shown as displaying a plurality of agents 112 with a geographic overlay 503 to illustrate their movements through a particular region as the simulation is performed. Each agent 112 is an autonomous agent representative of a vehicle, where each agent 112 is modeled as having its own attributes, behaviors, and decision-making behaviors.

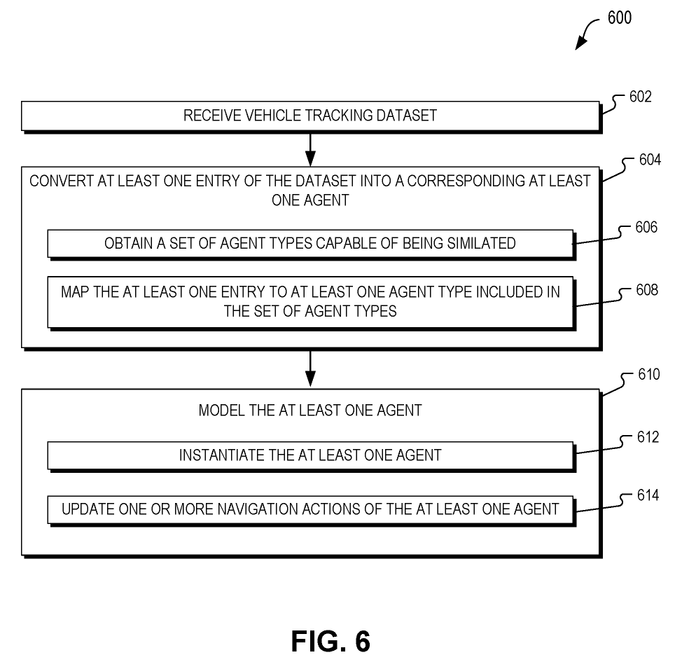

As discussed above, the speed with which a simulation scenario can be arranged or created and its resultant realism may be improved when agents 112 are based on the automated processing of recorded data and/or observations of actual movements of real-world vehicles. Thus, returning to FIG. 4, data interface module 412 includes routines, program instructions, objects, and/or data structures to ingest vehicle tracking dataset 105 and to convert its entries into agents 112 for a simulation. Further details regarding the operation of the data interface module 412 will be described in more detail below with reference to FIGS. 6-8.

FIG. 6 is a flow diagram of an example process 600 performed by an agent-based simulation platform, in accordance with aspects of the disclosure. In particular, process 600 is one example process performed by the data interface module 412 of FIG. 4 and/or the data interface module 110 of FIG. 1.

In a process block 602, the data interface module 412 receives vehicle tracking dataset 105. Next, in a process block 604, the data interface module 412 converts an entry of the vehicle tracking dataset 105 into a corresponding agent that is to be simulated the agent-based simulation platform. By way of example, referring to FIG. 4, data interface module 412 may convert ENTRY_1 of the vehicle tracking dataset 105 into a corresponding AGENT_1 of the agents 112. Similarly, data interface module 412 may also convert ENTRY_2 of the vehicle tracking dataset 105 into corresponding AGENT_2 of the agents 112. As mentioned above, each agent 112 is an autonomous agent representative of a vehicle, where each agent 112 includes its own attributes, behaviors, and decision-making behaviors as it is simulated. Thus, in some aspects, simulating an agent 112 is not just a replay of the recorded movements and data included in the corresponding entry of the vehicle tracking dataset 105. Instead, converting an entry of the vehicle tracking dataset 105 into a corresponding agent 112, as provided herein, includes using the entry as a guideline for determining the behavior and/or attributes of the corresponding agent 112. For example, the creation of an agent 112 by the data interface module 412, may take the vectors included in an entry of the vehicle tracking dataset 105 and use the locations, speeds, and other data as guidelines for simulating the navigation of the agent 112. For instance, the simulation may attempt to navigate from the initial location along the indicated course, changing heading, speed, and altitude if applicable. However, the agent 112 is constrained by the simulated physics of the platforms that are selected to represent them within the simulation. For example, a user may elect to use real world data describing the flight of a private plane but represent it within the simulation as a commercial airliner. Given that commercial airliners are less maneuverable, the simulated agent 112 will attempt to follow vectors included in the entry as objectives for navigation, but due to differences in airspeed and maneuverability may not follow them exactly. Additionally, because agents 112 are autonomous-capable of executing additional independent behavior-each agent 112 may deviate from the indicated vectors. For example, an agent may deviate from the vectors included in the entry in order to simulate maintaining minimum safe distances, in response to the emerging actions of other agents 112, and/or or in order to prioritize non-navigational objectives, such as intercepting a target that approaches within a given range. Additionally, users of the simulation platform may implement additional behavioral logic within their simulation that will cause an agent 112 to pause waypoint navigation, carry out other actions and then return to navigation and attempt to complete the specified waypoints after completing other actions.

As mentioned above, aspects of the present disclosure allow for a common data output (e.g., vehicle tracking dataset 105) to be provided to various different simulation tools and/or platforms. In some aspects, each simulation platform may have its own format for generating agents. In addition, each simulation platform may be limited in the types of agents it can and/or is intended to simulate. Accordingly, converting an entry into an agent may include one or more additional processes for correlating the entries included in the vehicle tracking dataset 105 to the types of agents that are to be simulated by the specific agent-based simulation platform 402. For example, process 600 further includes a process block 606 which includes the data interface module 412 obtaining a set of agent types that are capable of being simulated by the agent-based simulation platform 402. In some aspects, the set of agent types are specific to the particular agent-based simulation platform 402 and may be independent and distinct from agent types that other agent-based simulation platforms are capable of simulating. Next, in a process block 608, the data interface module 412 maps each entry included in the vehicle tracking dataset 105 to an agent type included in the set of agent types in order to generate agents 112. In some examples, the data interface module 412 maps an entry of the vehicle tracking dataset 105 to the agent types based on the entry’s first indication (e.g., type, name, or unique identifier, etc.).

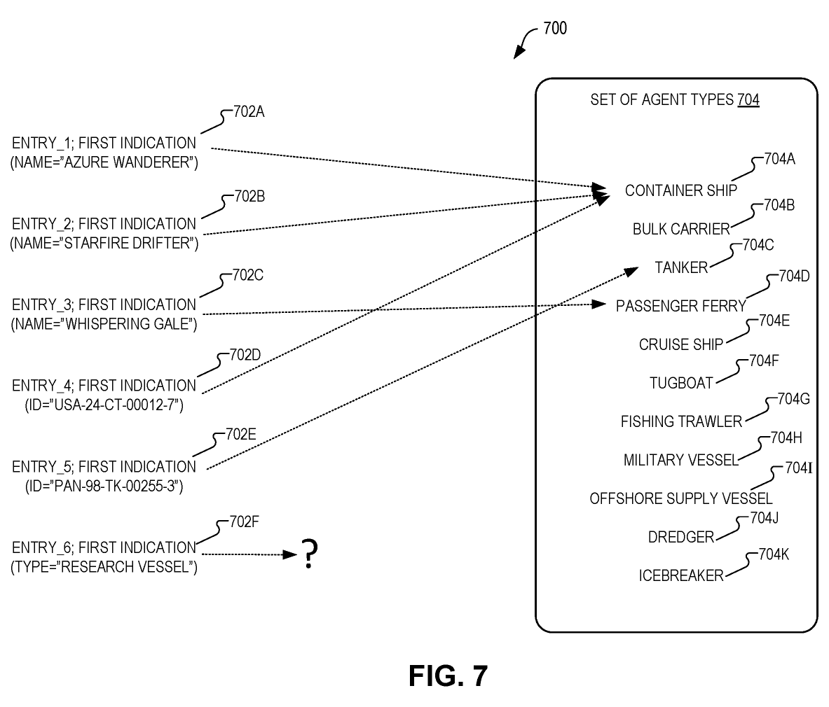

In some examples, the set of agent types are included in a lookup table that maps one or more first indications of an entry to a single agent type capable of being simulated by the agent-based simulation platform 402. For instance, FIG. 7 illustrates an example lookup table 700. As shown in FIG. 7, lookup table 700 includes a set of agent types 704. The set of agent types 704 may include a complete set of agent types 704A-704K that are capable of being simulated by the agent-based simulation platform 402. The lookup table 700 also maps entries (e.g., ENTRY_1, ENTRY_2, …, ENTRY_6, etc.) of the vehicle tracking dataset 105 to the agent types 704A-704K. In particular, the lookup table 700 maps each first indication 702A-702F to no more than a single agent type. For example, first indication 702A includes a ship name, where the lookup table 700 maps to the single agent type 704A (i.e., “CONTAINER SHIP”). Similarly, the first indication 702E includes a unique identification number which is mapped, by the lookup table 700, to the single agent type 704C (i.e., “TANKER”). In some aspects, lookup table 700 is a many-to-one lookup table that is configured to map a plurality of distinct first indications of different entries to a single agent type. For instance, FIG. 7 illustrates lookup table 700 as mapping the first indication 702A, the first indication 702B, and the first indication 702D to the agent type 704A. Thus, each of the entries corresponding to the first indications 702A, 702B, and 702D will be simulated as “CONTAINER SHIP” agent types within a simulation performed by the agent-based simulation platform 402.

In some examples, the mappings included in lookup table 700 are dynamic. For instance, in some examples, a user of the agent-based simulation platform 402 may specify which agent types are to be simulated as well as which agent types are to be used for specific types of vehicles included in the vehicle tracking dataset 105. For example, a user may provide user input indicating that private planes are to be represented within the simulation as commercial airliners. Accordingly, the data interface module 412 may be configured to dynamically update the lookup table 700 to change one or more mappings. By way of example, lookup table 700 may by dynamically updated by deleting the mapping between the first indication 702D and the agent type 704A (i.e., “CONTAINER SHIP”). A new mapping may then be added that maps the first indication 702D to another agent type such as agent type 704G (i.e., “FISHING TRAWLER”). Thus, ENTRY_4 will now be simulated as a fishing trawler as opposed to its original mapping which would have simulated ENTRY_4 as a container ship.

As mentioned above, aspects of the present disclosure may include a vehicle tracking dataset 105 that is based on recorded movements of a variety of different vehicles and may be generated by a variety of different vehicle tracking data sources which utilize a variety of data formats (e.g., AIS, ADS-B, RADAR, etc.). Thus, in some examples, the lookup table 700 may not be a complete mapping of all possible first indications. By way of example, FIG. 7 illustrates ENTRY_6 as including a first indication 702F that is a vehicle type “RESEARCH VESSEL”. As shown, lookup table 700 does not include an association or mapping of the first indication 702F to any of the agent types 704A-704K included in the set of agent types 704. Thus, in some embodiments, aspects of the present disclosure include assigning an agent type from the set of agent types 704 even when there is no pre-existing mapping of the first indication to any of the agent types included in the set of agent types 704.

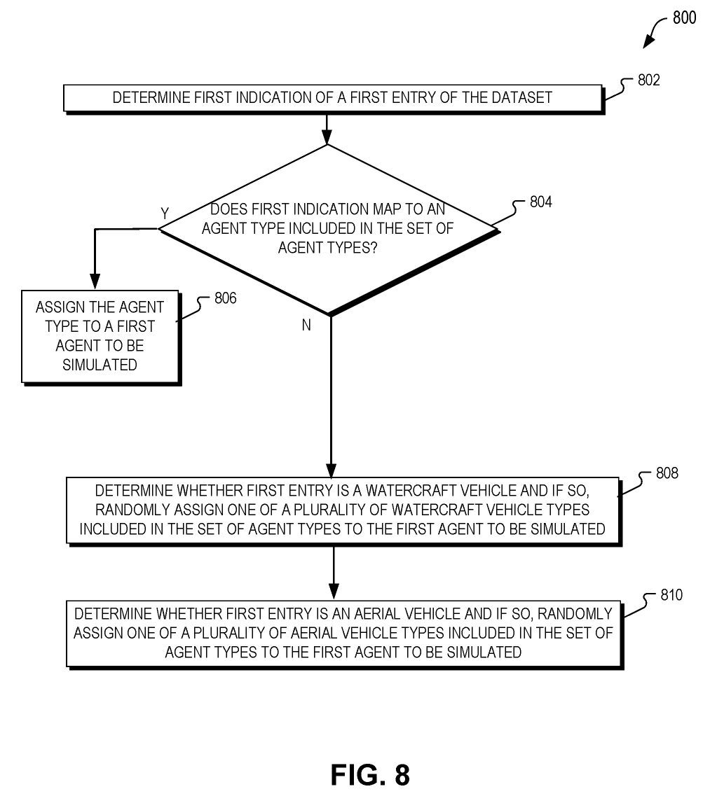

For example, FIG. 8 is a flow diagram of a process 800 of mapping entries to agent types including the assignment of agent types based on an unknown first indication discussed above, in accordance with aspects of the disclosure. Process 800 is one possible process performed by the data interface module 412 of FIG. 4. Process 800 will be described with reference to FIGS. 7 and 8.

In a process block 802, the data interface module 412 determines the first indication of an entry of the vehicle tracking dataset 105. In some aspects, determining the first indication includes extracting one or more fields from an entry that correspond to fields mapped in the lookup table 700. Next, in decision block 804, the data interface module 412 determines whether the first indication maps to an agent type included in the set of agent types. In the example of FIG. 7, the first indication 702C of ENTRY_3 is shown as mapping to the agent type 704D (i.e., “PASSENGER FERRY”). Thus, process 800 proceeds to process block 806 where the agent type 704D is assigned to an agent 112 that is to be simulated by the agent-based simulation platform 402.

However, if in decision block 804, the first indication does not map to any of the agent types included in the set of agent types 704, then the data interface module 412 may randomly assign an agent type from the set of agent types 704 for a corresponding agent 112 that is to be simulated. In some examples, the random assignment of an agent type is based on a determination of whether the entry in the vehicle tracking dataset 105 corresponds to a watercraft vehicle or to an aerial vehicle. For instance, FIG. 8 illustrates a process block 808 that includes the data interface module 412 determining whether the entry is a watercraft vehicle and if so, randomly assigning one of a plurality of watercraft vehicle types included in the set of agent types to an agent to be simulated. Similarly, process block 810 includes the data interface module 412 determining whether the entry is an aircraft vehicle and if so, randomly assigning one of a plurality of aircraft vehicle types included in the set of agent types to an agent to be simulated. In some aspects, the determination of whether the entry is an aircraft vehicle or a watercraft vehicle is based on the type of data that was used to generate the vehicle tracking dataset 105. For instance, the data interface module 412 may be configured to assume all entries generated from AIS data are watercraft vehicles, whereas all entries generated from ADS-B data correspond to aircraft vehicles. In some examples, the vehicle tracking dataset 105 includes one or more additional fields that identify the entry as an air, surface, land, or space vehicle.

Returning back to FIG. 6, the data interface module 412 iterates through the entries included in the vehicle tracking dataset 105 to convert each entry into a corresponding agent that is to be simulated by the agent-based simulation platform 402 (i.e., process block 604). Next, process block 610 includes modeling the agents 112 within a simulation of the agent-based simulation platform 402. In some examples, modeling the agents 112 includes instantiating one or more of the agents 112 (i.e., process block 612) and then updating one or more navigation actions of the instantiated agents 112 (i.e., process block 614).

In some aspects, process block 612 of instantiating an agent within agent-based simulation platform 402 includes creating a new, independent instance of an agent type (selected from agent types 704 of FIG. 1), giving it specific initial properties and behaviors (e.g., initial location, initial course, and/or initial speed as provided in the second indication 306 of FIG. 3), and making the agent active within the simulated environment. Next, in process block 614, one or more navigation actions of the instantiated agents 112 may be updated as the simulation progresses. In some aspects, updating the navigation actions of an agent 112 may include updating a location, a course, and/or a speed of the agent 112 based on one or more of the vectors included in the associated entry (e.g., vectors 308 of FIG. 3B).

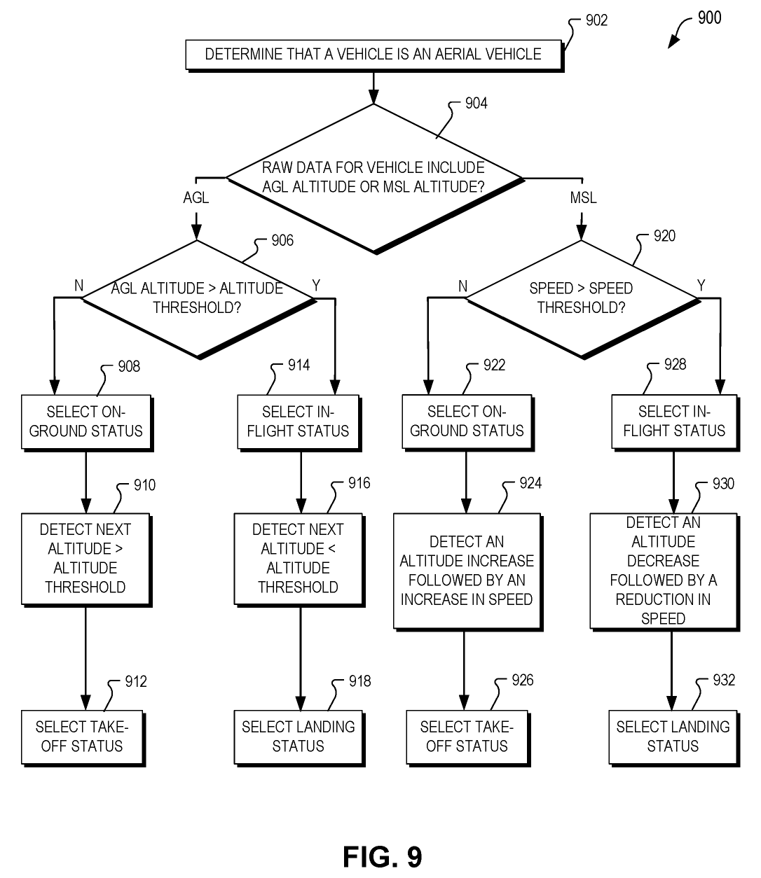

Referring back to FIG. 3B and as mentioned above, in some examples, a vector, such as vector 310 may include an optional status indicator 318. In some implementations, the status indicator 318 may be an aerial vehicle status that indicates whether an aircraft vehicle is in an in-flight status, an on-ground status, a landing status, or a take-off status. In some implementations, the aerial vehicle status provides an indication to the simulation engine to allow the correct initialization agents 112. For example, to ensure that aircraft that should enter the simulation at altitude and in-flight are initialized correctly, or that an aircraft originating from or terminating at an airport initiates the appropriate simulated takeoff and landing sequences. Additionally, in some implementations the vector data shown in FIG. 3B may contain time delay values denoted in seconds. These delay values are used to indicate how long after the start of a simulation an agent should be created, as well as to control how long aircraft or ships should remain stationary, in cases where an aircraft lands and subsequently takes off, or where a vessel anchors or arrives at a pier, remains stationary for some amount of time and then resumes navigation, etc. FIG. 9 is a flow diagram of an example process 900 of determining an aerial vehicle status, in accordance with aspects of the disclosure. Process 900 is one additional process performed by the data setup platform 104 of FIG. 1 and/or data setup platform 206 of FIG. 2 during the generation of the vehicle tracking dataset 105.

In a process block 902, the data setup platform 104 iterates through the raw 103 to determine whether entries corresponding to a respective vehicle are those of an aerial vehicle. In one example, determining whether a vehicle is an aerial vehicle includes determining whether the raw data 103 for a vehicle includes altitude information. In one aspect, altitude information that is above sea level may indicate that the vehicle is an aerial vehicle. In another aspect, speed indications included in the raw data 103 that are above a threshold may also indicate that a vehicle is an aerial vehicle.

In some aspects, the process used to determine the specific aerial vehicle status may depend, in part, on how the altitude information included in the raw data 103 is formatted. For example, some altitude data may be in an AGL (Above Ground Level) format, whereas other altitude data may be in an MSL (Mean Sea Level) format. AGL altitude information may be included in some of the raw data 103 to measure a vehicle’s altitude relative to the ground directly beneath the aircraft or object. AGL altitude information represents the vehicle’s height above the current terrain and may be used by the vehicle for avoiding obstacles and understanding the vehicles immediate proximity to the ground. MSL altitude information measures the vehicle altitude relative to the average sea level. MSL provides a consistent and standardized reference point for altitude measurement, regardless of the terrain below. MSL may be utilized for navigation, air traffic control, and maintaining safe separation between aircraft.

Thus, decision block 904 includes determining whether the recorded movements for a respective vehicle included in the raw data 103 are AGL altitude measurements or MSL altitude measurements. If AGL altitude is included, then process 900 proceeds to decision block 906 where the AGL altitude is compared to an altitude threshold. The altitude threshold represents an above-ground altitude for which vehicles above are assumed to be in-flight, whereas vehicles below it are assumed to be on the ground. Thus, if the AGL altitude is less than the altitude threshold then process block 908 makes an initial determination that the vehicle is in an on-ground status. If however, the AGL altitude is greater than the altitude threshold, then process block 914 makes an initial determination that the vehicle is in an in-flight status. However, as mentioned above, aspects of the present disclosure include further aerial vehicle statuses landing and take-off. That is, a take-off status may indicate that the vehicle is on the ground but is in the process of taking off. Similarly, the landing status may indicate that the vehicle is in flight, but is in the process of landing. Accordingly, process 900 includes additional steps for determining the take-off and landing statuses. For instance, after determining in process block 908 that the vehicle is in the on-ground status, process block 910 includes detecting a next altitude for the respective vehicle. That is, the next time-ordered instance of an AGL altitude for the vehicle may be compared to the altitude threshold. If the AGL altitude for the subsequent recorded instance is greater than the altitude threshold, then the initial determination for the aerial status of the vehicle is changed to a take-off status (e.g., process block 912). In other words, an AGL altitude that is below the altitude threshold indicates an on-ground status, but if the subsequent AGL altitude is above the altitude threshold, then its status is a take-off status.

Similarly, in process block 914, the initial determination for the aerial status was in-flight due to the AGL altitude being greater than the altitude threshold. If however, in process block 916, it is determined that the subsequent AGL altitude is less than the altitude threshold, then the initial determination for the aerial status of the vehicle is changed to a landing status (e.g., process block 918). Stated another way, an aerial vehicle with an AGL altitude greater than the altitude threshold may be initially determined to be in-flight, but a subsequent AGL altitude that is less than the altitude threshold means that the vehicle was actually in the process of landing and thus is in a landing status.

Returning back to decision block 904, if it is determined that altitude measurements for the vehicle are MSL altitudes, the process 900 proceeds to decision block 920. In decision block 920, the speed of a vehicle (as indicated in the raw data 103) is compared with a minimum speed threshold. In some aspects, a vehicle speed less than the minimum speed threshold indicates that the aerial vehicle is on the ground, whereas a vehicle speed that is greater than the minimum speed threshold indicates that the aerial vehicle is in flight. Thus, process block 922 includes selecting an initial on-ground status for the aerial vehicle in response to determining that the vehicle speed is less than the minimum speed threshold. Similarly, process block 928 includes selecting an initial in-flight status for the aerial vehicle in response to determining that the vehicle speed is greater than the minimum speed threshold.

In some aspects, further determination of whether these initial aerial vehicle status are actually a landing status or a take-off status includes the data setup platform 104 analyzing a plurality of time-ordered MSL altitudes and speeds for the vehicle. For example, in process blocks 924 and 926, if the subsequent time-ordered MSL altitudes and speeds indicate an altitude increase and a speed increase for the vehicle, then the aerial vehicle status is selected to be the take-off status. Similarly, in process blocks 930 and 932, if the subsequent time-ordered MSL altitudes and speeds indicate an altitude decrease followed by a reduction in the speed of the vehicle, then the aerial vehicle status is selected to be the landing status.

The processes, methods, functions, or modules explained above may be implemented in hardware, software, firmware, or any combination thereof. If implemented in software, the techniques may be stored on or transmitted as one or more instructions or code on a computer-readable medium. The techniques described may constitute computer-executable instructions embodied or stored within a tangible or non-transitory computer-readable medium, that when executed by a processor will cause the processor to perform the operations or acts described. Additionally, the processes may be embodied within hardware, such as an application specific integrated circuit (“ASIC”) or otherwise.

A tangible non-transitory computer-readable medium includes any mechanism that provides (i.e., stores) information in a form accessible by a machine (e.g., a computer, network device, personal digital assistant, manufacturing tool, any device with a set of one or more processors, etc.). For example, a machine-readable medium may include recordable or non-recordable media (e.g., read only memory (ROM), random access memory (RAM), magnetic disk storage media, optical storage media, flash memory devices, etc.).

In addition, the methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A computer-implemented method, performed by a data interface module of an agent-based simulation platform, the method comprising:
receiving a vehicle tracking dataset that is based on recorded movements of a plurality of vehicles, wherein the vehicle tracking dataset comprises at least one entry that includes:
a first indication of a type, a name, or a unique identifier of a respective vehicle;
a second indication of an initial location, an initial course, and an initial speed of the respective vehicle; and
at least one vector of a second location and a second speed of the respective vehicle, wherein the second location is subsequent to the initial location, and the second speed is subsequent to the initial speed;
converting the at least one entry into a corresponding at least one agent that is to be simulated by the agent-based simulation platform, wherein converting the at least one entry includes:
obtaining a set of agent types capable of being simulated by the agent-based simulation platform; and
mapping the at least one entry to at least one agent type included in the set of agent types based on the first indication of the at least one entry; and
modeling the at least one agent within a simulation of the agent-based simulation platform, wherein modeling the at least one agent includes:
instantiating the at least one agent with the at least one agent type, at the initial location, with the initial course, and at the initial speed; and then
updating one or more navigation actions of the at least one agent based on the at least one vector.

2. The computer-implemented method of claim 1, wherein the vehicle tracking dataset includes no more than one entry for each vehicle of the plurality of vehicles.

3. The computer-implemented method of claim 2, wherein the at least one entry is generated based on a plurality of instances of recorded movements for the respective vehicle.

4. The computer-implemented method of claim 1, wherein the set of agent types are included in a lookup table that maps the first indication to a single agent type.

5. The computer-implemented method of claim 4, wherein the lookup table is a many-to-one lookup table that is configured to map a plurality of distinct first indications of different entries to the single agent type.

6. The computer-implemented method of claim 1, further comprising:
determining that the at least one entry does not map to any agent type included in the set of agent types; and in response thereto,
randomly assigning an agent type from the set of agent types to the at least one entry.

7. The computer-implemented method of claim 6, wherein randomly assigning the agent type to the at least one entry includes:
randomly selecting one of a plurality of watercraft vehicle types included in the set of agent types to assign to the at least one entry in response to determining that the at least one entry corresponds to a watercraft vehicle; and
randomly selecting one of a plurality of aerial vehicle types included in the set of agent types to assign to the at least one entry in response to determining that the at least one entry corresponds to an aerial vehicle.

8. The computer-implemented method of claim 1, wherein the respective vehicle is an aerial vehicle and wherein the at least one vector further includes an aerial vehicle status selected from a group of aerial vehicle statuses that comprises:
an in-flight status that indicates that the aerial vehicle is in-flight at the second location;
an on-ground status that indicates that the aerial vehicle is landed at the second location;
a landing status that indicates that the aerial vehicle is landing at the second location; and
a take-off status that indicates that the aerial vehicle is taking off at the second location.

9. The computer-implemented method of claim 1, wherein the at least one vector further includes a delay status that indicates that the respective vehicle is not moving at the second location.

10. An agent-based simulation system, comprising:
an agent-based simulation platform that includes:
a first communication interface;
a first processor coupled to the first communication interface; and
a first memory coupled to the first processor, the first memory having instructions stored therein, which when executed by the first processor, direct the agent-based simulation platform to:
receive, via the communication interface, a vehicle tracking dataset that is based on recorded movements of a plurality of vehicles, wherein the vehicle tracking dataset comprises at least one entry that includes:
a first indication of a type, a name, or a unique identifier of a respective vehicle;
a second indication of an initial location, an initial course, and an initial speed of the respective vehicle; and
at least one vector of a second location and a second speed of the respective vehicle, wherein the second location is subsequent to the initial location, and the second speed is subsequent to the initial speed;
convert the at least one entry into a corresponding at least one agent that is to be simulated by the agent-based simulation platform, wherein the instructions to convert the at least one entry includes instructions to:
obtain a set of agent types capable of being simulated by the agent-based simulation platform; and
map the at least one entry to at least one agent type included in the set of agent types based on the first indication of the at least one entry; and
model the at least one agent within a simulation of the agent-based simulation platform, wherein the instructions to model the at least one agent includes instructions to:
instantiate the at least one agent with the at least one agent type, at the initial location, with the initial course, and at the initial speed; and then
update one or more navigation actions of the at least one agent based on the at least one vector.

11. The agent-based simulation system of claim 10, further comprising:
a data setup platform that includes:
a second communication interface;
a second processor coupled to the second communication interface; and
a second memory coupled to the second processor, the second memory having instructions stored therein, which when executed by the second processor, direct the data setup platform to:
receive, via the second communication interface, a plurality of instances of recorded movements for the respective vehicle; and
generate the vehicle tracking dataset based on the plurality of recorded movements.

12. The agent-based simulation system of claim 11, wherein the instructions to generate the vehicle tracking dataset includes instructions to combine multiple recorded movements of the respective vehicle into a single entry, such that the vehicle tracking dataset includes no more than one entry for each vehicle of the plurality of vehicles.

13. The agent-based simulation system of claim 11, wherein the instructions to generate the vehicle tracking dataset includes instructions to:
determine that the respective vehicle is an aerial vehicle;
select an aerial vehicle status for the respective vehicle, wherein the aerial vehicle status is selected from a group of aerial vehicle statuses that comprise:
an in-flight status that indicates that the aerial vehicle is in-flight at the second location;
an on-ground status that indicates that the aerial vehicle is landed at the second location;
a landing status that indicates that the aerial vehicle is landing at the second location; and
a take-off status that indicates that the aerial vehicle is taking off at the second location; and
add the aerial vehicle status to the at least one vector for the respective vehicle.

14. The agent-based simulation system of claim 13, wherein at least one instance of the recorded movements for the respective vehicle includes an above ground level (AGL) altitude of the respective vehicle, and wherein the instructions to select the aerial vehicle status for the respective vehicle includes instructions to:
compare the AGL altitude to an altitude threshold.

15. The agent-based simulation system of claim 13, wherein at least one instance of the recorded movements for the respective vehicle includes a mean sea level (MSL) altitude of the respective vehicle, and wherein the instructions to select the aerial vehicle status for the respective vehicle includes instructions to:
compare a speed of the respective vehicle to a minimum speed threshold;
select an on-ground status in response to determining that the speed of the respective vehicle is less than the minimum speed threshold; and
select an in-air status in response to determining that the speed of the respective vehicle is greater than the minimum speed threshold.

16. The agent-based simulation system of claim 15, wherein the instructions to select the aerial vehicle status for the respective vehicle further includes instructions to:
analyze a plurality of time-ordered MSL altitudes and speeds of the respective vehicle;
select the landing status in response to determining that the plurality of time-ordered MSL altitudes and speeds indicates an altitude decrease followed by a reduction in speed of the respective vehicle; and
select the take-off status in response to determining that the plurality of time-ordered MLS altitudes and speeds indicates an altitude increase and a speed increase of the respective vehicle.

17. The agent-based simulation system of claim 11, wherein the instructions to receive the plurality of instances of recorded movements for the respective vehicle includes instructions to receive automatic identification system (AIS) data broadcast by the plurality of vehicles, automatic surveillance-broadcast (ADS-B) data broadcast by the plurality of vehicles, or sensor data that indicates the recorded movements of the plurality of vehicles.

18. The agent-based simulation system of claim 10, wherein the instructions to map the at least one entry includes instructions to direct the agent-based simulation platform to:
determine that the at least one entry does not map to any agent type included in the set of agent types; and in response thereto,
randomly assign an agent type from the set of agent types to the at least one entry.

19. The agent-based simulation system of claim 10, wherein the set of agent types are included in a lookup table that maps the first indication to a first agent type of the set of agent types, and wherein the instructions to map the at least one entry include instructions to:
dynamically update the lookup table to change one or more mappings by:
deleting a mapping between the first indication and the first agent type; and
adding a mapping between the first indication and a second agent type of the set of agent types.

20. One or more non-transitory computer-readable media storing computer-executable instructions that upon execution cause one or more processors to perform acts comprising:
receive a vehicle tracking dataset that is based on recorded movements of a plurality of vehicles, wherein the vehicle tracking dataset comprises at least one entry that includes:
a first indication of a type, a name, or a unique identifier of a respective vehicle;
a second indication of an initial location, an initial course, and an initial speed of the respective vehicle; and
at least one vector of a second location and a second speed of the respective vehicle, wherein the second location is subsequent to the initial location, and the second speed is subsequent to the initial speed;
convert the at least one entry into a corresponding at least one agent that is to be simulated by an agent-based simulation platform, wherein the instructions to convert the at least one entry includes instructions to:
obtain a set of agent types capable of being simulated by the agent-based simulation platform; and
map the at least one entry to at least one agent type included in the set of agent types based on the first indication of the at least one entry; and
model the at least one agent within a simulation of the agent-based simulation platform, wherein the instructions to model the at least one agent includes instructions to:
instantiate the at least one agent with the at least one agent type, at the initial location, with the initial course, and at the initial speed; and then
update one or more navigation actions of the at least one agent based on the at least one vector.
